(19) United States
(12) Patent Application Publication
(10) Pub. No.: US 2016/0275533 A1
(43) Pub. Date: Sep. 22, 2016

(54) Segment Membership Determination for Content Provisioning

(71) Applicant: Adobe Systems Incorporated, San Jose, CA (US)

(72) Inventors: Kevin Gary Smith, Lehi, UT (US); William Brandon George, Pleasant Grove, UT (US); Walter Wei-Tuh Chang, San Jose, CA (US)

(21) Appl. No.: 14/660,024

(22) Filed: Mar. 17, 2015

(51) Int. Cl. G06Q 30/02; G06F 17/30

(52) U.S. Cl. CPC G06Q 30/0204; G06F 17/30539; G06F 17/3053; G06F 17/30663; G06F 17/30687

(57) ABSTRACT

A system determines whether a user is a member of a segment, and this segment membership determination can be used to determine what content is provided to the user. Each segment has a corresponding set of criteria that includes multiple different elements describing users in the segment. A confidence value that the user is included in the segment is generated based on user data, and this confidence value can be used in different manners, such as to determine what content to provide to the user or to determine a financial value of providing content to the user. The confidence value is based on a fuzzy matching technique that generates element scores indicating how well the elements are satisfied by the user. The confidence value can also be based on weighted element scores, and estimates generated for elements for which user data is unknown.

### BACKGROUND

As computing technology has advanced, the amount of information available to users has grown tremendously. Various services provide content to users, and given the vast amount of information content available and the differences among users, it can be difficult for services to determine what information to provide to what users. This difficulty can be exacerbated when information regarding users is not known. These difficulties can lead to situations in which the information provided to a user by a service is information that is less desirable or useful to the user.

### SUMMARY

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

In accordance with one or more aspects, whether a user is included in a segment is determined by obtaining, from a data store of the device, segment membership criteria for the segment. The segment membership criteria includes multiple different elements. For at least a first element of the multiple elements, an element score is generated that indicates how well the element is satisfied by the user, the element score being one of at least three different values. A weight for each of the multiple elements is also obtained from the data store. A weighted score is generated by the device for each of the multiple elements, the weighted score for each of at least the first element being generated by applying the weight for the element to the element score for the element. A confidence value that the user is included in the segment is generated by combining the weighted scores for the multiple elements.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 illustrates an example device implementing the segment membership determination for content provisioning in accordance with one or more embodiments.

FIG. 2 illustrates the probabilistic segment membership determination system in additional detail in accordance with one or more embodiments.

FIG. 3 illustrates an example of generation of element scores in accordance with one or more embodiments.

FIG. 4 is a flowchart illustrating an example process for implementing segment membership determination for content provisioning in accordance with one or more embodiments.

FIG. 5 illustrates an example system that includes an example computing device that is representative of one or more computing systems and/or devices that may implement the various techniques described herein.

### DETAILED DESCRIPTION

Segment membership determination for content provisioning is discussed herein. A system determines whether a particular user is a member of a particular segment, and this segment membership determination can be used to determine what content is provided to the user. A user can be a member of one or more different segments, each segment being a collection or grouping of the user population. Each segment has a corresponding set of criteria, referred to as the segment membership criteria, that includes multiple different elements describing users in the segment. These elements can include, for example, the age of the user, the gender of the user, the income of the user, whether and/or how often the user has accessed a particular service before, which other service the user accessed prior to accessing a current service, and so forth. A confidence value that the user is included in the segment is generated, and this confidence value can be used in different manners, such as to determine what content to provide to the user, to determine a financial value of providing content to the user, and so forth. The confidence value that the user is included in the segment represents a confidence that the user is part of the segment (e.g., a confidence that the user satisfies the set of criteria corresponding to the segment).

The confidence value that a user is included in a segment is based on a fuzzy matching technique. Instead of using Boolean values indicating that an element does or does not apply to a user, an element score indicating how well the element is satisfied by the user is generated. For example, an element may be that the user has visited a particular Web site 10 times. If the user has visited the particular Web site only 8 times, the element score indicating how well the element is satisfied by the user can be set to 0.8. The confidence value that the user is included in the segment is determined by combining (e.g., averaging or adding) the element scores for the multiple elements in the set of criteria.

Additionally, the system can assign weights to the element scores for different elements to indicate the importance of each element relative to the other elements in the set of criteria. A weighted element score for each element can be generated by applying the weight of the element to the element score for the element (e.g., multiplying the weight of the element by the element score for the element). The confidence value that the user is included in the segment can then be determined by combining (e.g., averaging or adding) the weighted element scores for the multiple elements in the set of criteria.

Additionally, in some situations the values for a user for one or more elements may be unknown. For example, an element may be that the age of the user is at least 30, and the system does not have data indicating the age of the user. In this situation, the system estimates the element score for the element based on additional information available to the system. This additional information can be, for example, general statistical information about users (e.g., the typical lifespan of humans), publicly available information, other information known to the system (e.g., the age range of users of the system or another service), and additional information regarding other users of the system or other service (e.g., how well other non-age data of the user matches the data of other users of the system or other service).

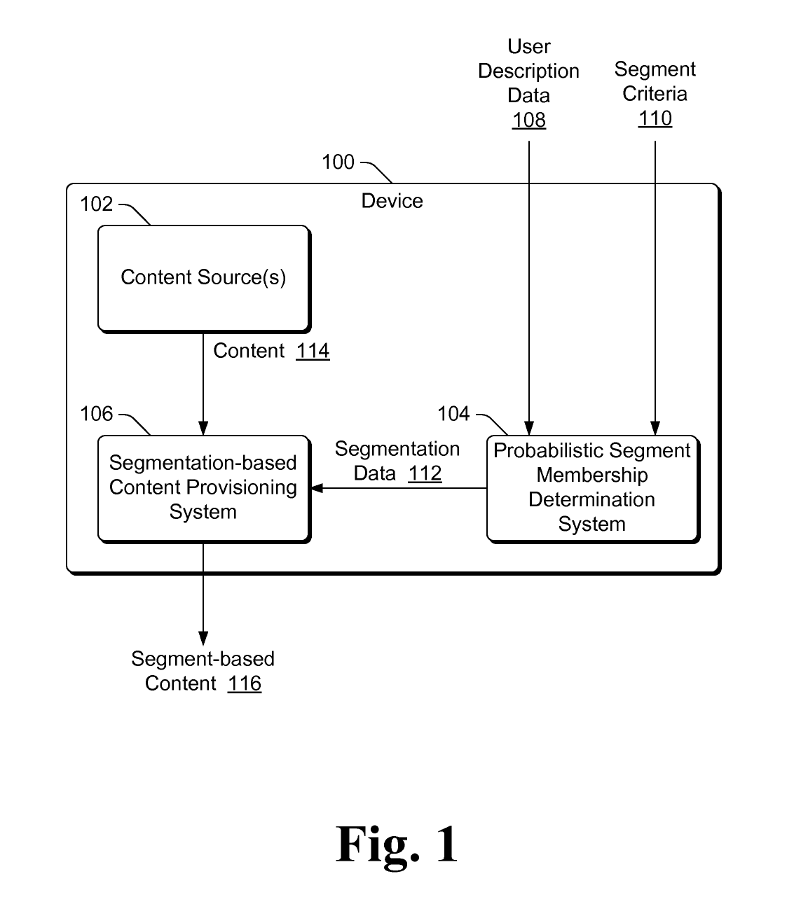

FIG. 1 illustrates an example device 100 implementing the segment membership determination for content provisioning in accordance with one or more embodiments. The device 100 can be any of a variety of different types of computing devices, such as a server computer, a desktop computer, a laptop or netbook computer, a tablet or notepad computer, a mobile station, an entertainment appliance, a set-top box communicatively coupled to a display device, a television or other display device, a cellular or other wireless phone, a game console, an automotive computer, and so forth.

The device 100 includes one or more content sources 102, a probabilistic segment membership determination system 104, and a segmentation-based content provisioning system 106. Although illustrated as being part of the computing device 100, any of the one or more sources 102, the system 104, the system 106, or combinations thereof can be implemented on different ones of multiple computing devices. Additionally, any of the one or more sources 102, the system 104, and the system 106, or combinations thereof can be implemented across multiple computing devices. When multiple computing devices are used, the computing devices can be communicatively coupled to one another using any of a variety of wired or wireless connections, including any of a variety of different networks, such as the Internet, a local area network (LAN), a phone network, an intranet, other public and/or proprietary networks, combinations thereof, and so forth.

The probabilistic segment membership determination system 104 obtains user description data 108, which is information describing characteristics of a user. The user description data 108 can be obtained in any of a variety of different manners, such as provided by the user himself or herself, gathered by the system 104 as the user accesses different services (e.g., Web sites), gathered by other services or systems and provided to the probabilistic segment membership determination system 104, and so forth.

The probabilistic segment membership determination system 104 also obtains segment criteria 110 for one or more segments. The segment criteria 110 includes one or more elements that describe characteristics of a user that is a member of a segment. These elements can include, for example, the age of the user, the gender of the user, the income of the user, whether and/or how often the user has accessed a particular service before, which other service the user accessed prior to accessing a current service, and so forth. The segment criteria 110 can be obtained in any of a variety of different manners, such as provided by the segmentation-based content provisioning system 106, provided by another device or service, and so forth.

The probabilistic segment membership determination system 104 generates a confidence value indicating a confidence that a user is included in a segment. The system 104 generates the confidence value based on a fuzzy matching technique in which an element score indicating how well the element is satisfied by the user is generated (rather than a Boolean value indicating that an element is or is not satisfied by a user). The system 104 can also assign weights to the element scores for different elements to indicate the importance of each element relative to the other elements in the set of criteria, in which case the element score that is generated is a weighted element score. Additionally, in some situations the values for a user for one or more elements may be unknown. In such situations, the system 104 estimates the confidence value for the element based on additional information available to the system 104. The operation of system 104, including generating confidence values and values for unknown elements, is discussed in more detail below.

The probabilistic segment membership determination system 104 communicates the segmentation data 112 to the segmentation-based content provisioning system 106. The segmentation data 112 identifies, for each of one or more segments, a confidence value that the user is a member of the segment (as determined by the system 104 based on the user description data 108 and the segment criteria 110).

The segmentation-based content provisioning system 106 determines what content, if any, to provide to a user based on the segmentation data 112. Various different content 114 is available to the system 106 from the one or more content sources 102, and the system 106 can select from this content and provide the appropriate segment-based content 116 to the user. The content can be any of a variety of content that can be displayed or otherwise presented (e.g., played back audibly, played back tactually, etc.). The system 106 can display or otherwise present content itself, or provide an indication to another device or system of what content is to be displayed or otherwise presented by that other device or system (which can obtain the content from the system 106 or directly from the content sources 102).

The determination of what content, if any, to provide to a user can be made by the segmentation-based content provisioning system 106 in a variety of different manners. In one or more embodiments, the system 106 determines what content to display or otherwise present. For example, particular content from a content source 102 is displayed in response to the segmentation data 112 including a confidence value that the user is a member of a particular segment that satisfies a threshold value, and other content from a content source 102 is displayed in response to the segmentation data 112 including a confidence value that the user is a member of a particular segment that does not satisfy the threshold value. Additionally or alternatively, the system 106 determines whether to display content or how much to pay to display content (e.g., a financial value to the system 106 to be able to display content). For example, particular content (e.g., an advertisement) is displayed in response to the segmentation data 112 including a confidence value that the user is a member of a particular segment that satisfies a threshold value, and no content is displayed in response to the segmentation data 112 including a confidence value that the user is a member of a particular segment that does not satisfy the threshold value. By way of another example, an amount that an entity (e.g., the system 106 or an organization controlling the system 106) is willing to pay to display an advertisement is based on the confidence value in the segmentation data 112—the larger the confidence value, the more money the entity is willing to pay.

The segmentation-based content provisioning system 106 can also use multiple different threshold values. For example, the segmentation-based content provisioning system 106 can use two threshold values, a lower threshold value and a higher threshold value. One amount of money is paid to display particular content (e.g., an advertisement) in response to the segmentation data 112 including a confidence value that the user is a member of a particular segment that satisfies the upper threshold value, another amount of money (less than the amount paid in response to the confidence value satisfying the upper threshold value) is paid to display the particular content in response to the segmentation data 112 including a confidence value that the user is a member of a particular segment that satisfies the lower threshold value but does not satisfy the upper threshold value, and no content is displayed in response to the segmentation data 112 including a confidence value that the user is a member of a particular segment that does not satisfy the lower threshold value.

Reference is made herein to a threshold value being satisfied. A threshold value being satisfied refers to a particular value being greater than (or greater than or equal to) the threshold value.

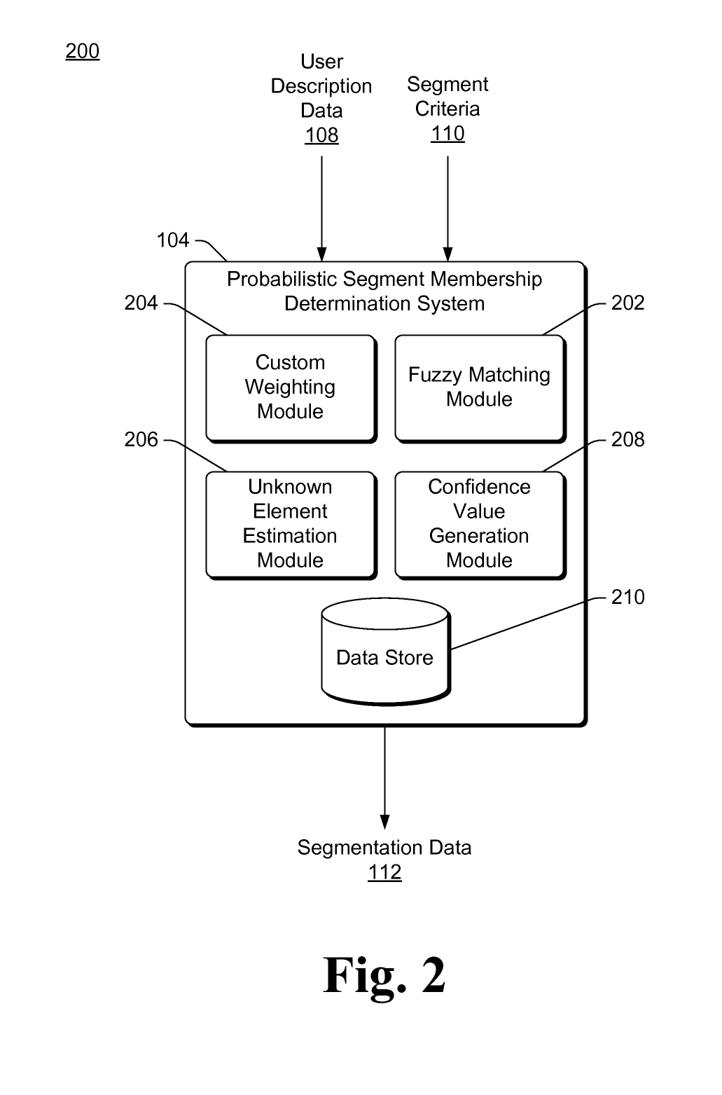

FIG. 2 illustrates the probabilistic segment membership determination system 104 in additional detail in accordance with one or more embodiments. The probabilistic segment membership determination system 104 includes a fuzzy matching module 202, a custom weighting module 204, an unknown element estimation module 206, and a confidence value generation module 208. Although particular functionality is discussed herein with reference to particular modules, it should be noted that the functionality of individual modules discussed herein can be separated into multiple modules, and/or at least some functionality of multiple modules can be combined into a single module.

The fuzzy matching module 202 generates, for each of multiple elements in a set of criteria for a segment, an element score indicating how well the element is satisfied by the user. The user data description data 108 describing characteristics of a user, and the obtained segment criteria 110, are stored in a data store 210. The data store 210 can be implemented as any of a variety of different storage mechanisms, such as random access memory (RAM), Flash memory, a magnetic disk, and so forth. The user data description data 108 and the segment criteria 110 can be stored in the data store 210 temporarily (e.g., while a confidence value for the user is being generated), or maintained in the data store 210 long-term (e.g., for days, weeks, etc.).

Each element score generated by the fuzzy matching module 202 is an indication of how well the element is satisfied by the user. The element score can be any of three or more different values, ranging from a value indicating the user does not satisfy the element at all to a value indicating the user fully satisfies the element, and may be any value in between. For example, if an element is not satisfied at all by the user then the element score can be 0.0, if an element is fully satisfied by the user then the element score can be 1.0, and if the element is somewhat or partially satisfied (somewhere between not satisfied at all and fully satisfied) then the element score can be some value between 0.0 and 1.0.

The fuzzy matching module 202 can generate the element score in any of a variety of different manners. In one or more embodiments, the element score is generated by determining how much of the element has been satisfied (e.g., dividing the user data for the element by the value of the element). For example, if an element indicates that a particular Web site is to have been accessed ten times and the user has accessed the Web site six times, then the element score can be 0.6 (6÷10=0.6). Additionally or alternatively, the element score is generated by determining how close an element is to being satisfied (e.g., based on a difference between the user data for the element and the value of the element). For example, if an element indicates that the user age is to be at least 30 years old, and the user is 27 years old, then the element score can be 0.9 (1430−27)+30=0.9).

The manner in which fuzzy matching module 202 generates the element score for a particular element can be determined in a variety of different manners. In one or more embodiments, an indication of how to generate the element score is included in the segment criteria 110. Additionally or alternatively, the fuzzy matching module 202 can be pre-configured with an indication of how to generate the element score for a particular element, the fuzzy matching module 202 can obtain an indication of how to generate the element score from another device or service, and so forth.

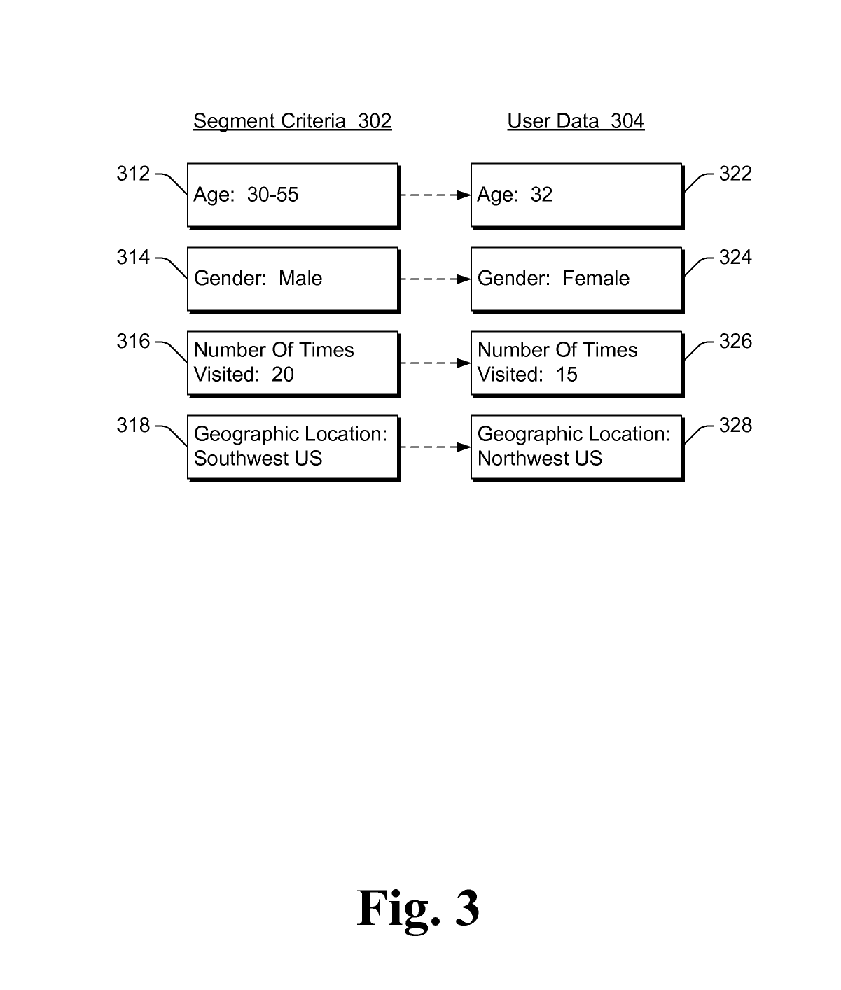

FIG. 3 illustrates an example of generation of element scores in accordance with one or more embodiments. In the example of FIG. 3, the fuzzy matching module 202 compares segment criteria 302 for a particular segment to user data 304 for a particular user. The segment criteria 302 includes four elements: age element 312 indicating an age range for the user to be in, gender element 314 indicating a gender the user is to have, a visitation element 316 indicating a number of times the user is to have previously visited a particular Web site, and a geographic location element 318 indicating a geographic location that the user is to live in.

The user data 304 for a particular user includes: age data 322 indicating the age of the user, gender data 324 indicating the gender of the user, visitation data 326 indicating a number of times the user has previously visited the particular Web site, and geographic location data 328 indicating the geographic location that the user lives in. This different data for the user is also referred to as different characteristics of the user (e.g., an age characteristic, a gender characteristic, a visitation characteristic, and a geographic location characteristic).

The fuzzy matching module 202 compares the age data 322 to the age element 312, determines that the age element 312 is fully satisfied, and generates an element score for the age element 312 of 1.0. The fuzzy matching module 202 compares the gender data 324 to the gender element 314, determines that the gender element 314 is not satisfied at all, and generates an element score for the gender element 314 of 0.0. The fuzzy matching module 202 compares the visitation data 326 to the visitation element 316, determines that the visitation element 316 is partially satisfied, and generates an element score for the visitation element 316 of 0.75 (15÷20=0.75). The fuzzy matching module 202 compares the geographic location data 328 to the geographic location element 318, determines that the geographic location element 318 is partially satisfied (e.g., in the US but not the southwest US), and generates an element score for the geographic location element 318 of 0.5 (e.g., due to the user living in a geographic location that is adjacent to the location identified in the geographic location element 318).

Returning to FIG. 2, the fuzzy matching module 202 communicates or otherwise makes available to the custom weighting module 204 (or the confidence value generation module 208) the generated element scores. The custom weighting module 204 generates, for each of multiple elements in a set of criteria for a segment, a weighted element score by applying a weight for the element to the element score for the element. The weight of an element indicates the importance of the element, relative to the other elements in the set of criteria, in generating the confidence value that the user is included in the segment. The weights for particular elements can be obtained in a variety of different manners. In one or more embodiments, the weights are included in the segment criteria 110. Additionally or alternatively, the custom weighting module 204 can obtain an indication of the weights from another device or service, the custom weighting module 204 can obtain an indication of the weights from an administrator or user of the probabilistic segment membership determination system 104, and so forth.

The custom weighting module 204 applies the weights for elements to the element scores for those elements as generated by the fuzzy matching module 202. In one or more embodiments, a weight has a value between 0.0 and 1.0, an element score has a value between 0.0 and 1.0, and the weighted score for an element is generated by multiplying the element score for the element and the weight for the element. The weights for the elements can, but need not, add up to a particular number (e.g., 1.0).

The use of weights allows a confidence value that more accurately reflects the desires of the organization or person that is making determinations based on whether a user is a member of a particular segment. Such an organization or person can assign the weights based on the organization's or person's desire or belief as to what is more important for determining segment membership.

By way of example, referring again to FIG. 3, assume that the age element 312 has a weight of 0.2, the gender element 314 has a weight of 0.2, the visitation element 316 has a weight of 0.6, and the geographic location element 318 has a weight of 0.2. Further assume that the elements 312-318 have element scores as discussed in the example above. Using these weights and element scores, the custom weighting module 204 generates weighted scores as follows. The custom weighting module 204 generates a weighted score of 0.2 (0.2×1.0=0.2) for the age element 312. The custom weighting module 204 generates a weighted score of 0.0 (0.2×0.0=0.0) for the gender element 314. The custom weighting module 204 generates a weighted score of 0.45 (0.6×0.75=0.45) for the visitation element 316. The custom weighting module 204 generates a weighted score of 0.1 (0.2×0.5=0.45) for the geographic location element 318.

Returning to FIG. 2, the unknown element estimation module 206 generates, for an element for which the data value of the user is unknown, an estimate of how well the element is satisfied by the user, which is used as the element score for the element. The unknown element estimation module 206 communicates or otherwise makes available to the custom weighting module 204 (or the confidence value generation module 208) the generated element scores for such elements for which the user data is unknown. For example, if the gender data 324 of FIG. 3 were to be unknown, then the unknown element estimation module 206 generates an element score for the gender element 314. The unknown element estimation module 206 can use various data from various sources to generate an element score for an element for which the user data is unknown.

In one or more embodiments, the unknown element estimation module 206 generates an element score for an element for which the user data is unknown using general statistics associated with the element based on possible values of user data for the element. The general statistics information can be pre-configured in the unknown element estimation module 206, can be obtained from another device or service, and so forth. The unknown element estimation module 206 determines a total number of possible values for the user data, and generates an element score by dividing the number of values included in the data element by the number of possible values for the user data.

For example, referring to FIG. 3, if the gender of the user is unknown, the unknown element estimation module 206 can determine that there are two possible genders (male and female), and assign an element score of 0.5 (which is 1 (the number of genders identified in the gender element 314) divided by 2 (the number of possible values for the user data)). By way of another example, referring to FIG. 3, if the age of the user is unknown, the unknown element estimation module 206 can determine that there are 110 different possible ages (assuming ages 1-111), and assign an element score of 0.24 (which is 26 (the number of possible values for age given the age range of 30-55 in the age element 312) divided by 110 (the number of possible values for the user data)).

Additionally or alternatively, the unknown element estimation module 206 generates an element score for an element for which the user data is unknown using public data associated with the element. Public data refers to information that is generally accessible or available to the public, as opposed to proprietary information available only to select services or systems (e.g., a Web service provider). For example, the number of people under the age of 30 that live in the US is public data, whereas the number of people under the age of 30 that are registered to use a particular Web service is proprietary information. Using public data differs from using general statistics in that using public data relies on information that is available to the public rather than just numeric probabilities. By way of example, public data can be data indicating the percentage of the population of the world (or a particular geographic region) in a particular age range. The unknown element estimation module 206 determines how many people satisfy (e.g., a percentage of the population that satisfies) the element based on public data, and uses that number as the element score.

The public data can be obtained in a variety of different manners. In one or more embodiments, the probabilistic segment membership determination system 104 is pre-configured with the public data. Additionally or alternatively, the public data can be obtained from an administrator of the probabilistic segment membership determination system 104, from another device or service (e.g., a Web-based encyclopedia, a government Web server), and so forth.

For example, referring to FIG. 3, if the age of the user is unknown, the unknown element estimation module 206 can determine, based on public data, that 33% of the population is in the age range of 30-55. Thus, the unknown element estimation module 206 determines an element score of 0.33 for the age element 312. By way of another example, referring to FIG. 3, if the geographic location in which the user lives is unknown, the unknown element estimation module 206 can determine, based on public data, that 22% of the population of the US lives in the southwest US. Thus, the unknown element estimation module 206 determines an element score of 0.22 for the geographic location element 318.

Additionally or alternatively, the unknown element estimation module 206 generates an element score for an element for which the user data is unknown using first party data associated with the element. First party data refers to information that is accessible or available to a limited number of people, such as a single company, organization, or other entity. First party data is also referred to as proprietary data. First party data differs from public data in that the first party data is not available to the general public. By way of example, first party data can be data indicating the percentage of the users of a particular service or company in a particular age range or having a particular gender. The unknown element estimation module 206 determines how many people satisfy (e.g., a percentage of the population that satisfies) the element based on first party data, and uses that number as the element score.

The first party data is typically received from or on behalf of a service or system for which the membership in a segment is being determined. For example, a particular Web service may provide shopping services, social media services, electronic mail services, and so forth. Information regarding the users of that particular Web service is maintained by that particular Web service or by some other service on behalf of that particular Web service. This information regarding the users of that particular Web service is the first party data.

For example, referring to FIG. 3, assume the segment criteria is for a particular Web service and that the age of the user is unknown. The unknown element estimation module 206 can determine, based on first party data from the particular Web service, that 65% of the users of the particular Web service are in the age range of 30-55. Thus, the unknown element estimation module 206 determines an element score of 0.65 for the age element 312. By way of another example, referring to FIG. 3, if the geographic location in which the user lives is unknown, the unknown element estimation module 206 can determine, based on first party data from the particular Web service, that 10% of the users of the particular Web service live in the southwest US. Thus, the unknown element estimation module 206 determines an element score of 0.1 for the geographic location element 318.

Additionally or alternatively, the unknown element estimation module 206 generates an element score for an element for which the user data is unknown using information matching or other machine learning techniques. First party data regarding a particular service or system for which membership in a segment is being determined is obtained. The unknown element estimation module 206 uses such techniques and the first party data to compare user data for the user to user data of other users of the particular service or system. The unknown element estimation module 206 determines how well the user data for the other users matches the user data for the user, and determines an element score based on this determination. For purposes of determining how well the user data for the other users matches the user data for the user, the user data other than the unknown data is used.

By way of example, referring again to FIG. 3, assume the segment criteria is for a particular Web service and that the age of the user is unknown. The unknown element estimation module 206 analyzes the user data for other users of the particular Web service, and identifies other users that have matching (e.g., the same) user data as the user (e.g., are female, have visited the Web service 15 times, and live in the Northwest US). The unknown element estimation module 206 determines how many of those other users that have matching user data (e.g., a percentage of the other users that have matching user data), and uses that number as the element score. For example, if 65% of the users of the particular Web service that are female, have visited the Web service 15 times, and live in the Northwest US also are between the ages of 30 and 55, then the unknown element estimation module 206 determines an element score for the age element 312 as 0.65.

It should be noted that, when analyzing the user data for other users of the particular Web service, additional user data that is not included in the segment criteria 302 can be used. For example, assume the segment criteria is for a particular Web service and that the age of the user is unknown. Further assume that additional user data is included in the user data 304 (although not shown in FIG. 3), such as what range the user's income is in (e.g., the $50,000-$75,000 range). The unknown element estimation module 206 analyzes the user data for other users of the particular Web service, and identifies other users that have matching (e.g., the same) user data as the user (e.g., are female, have visited the Web service 15 times, live in the Northwest US, and have an income in the $50,000-$75,000 range). The unknown element estimation module 206 determines how many of those other users that have matching user data (e.g., a percentage of the other users that have matching user data), and uses that number as the element score. For example, if 70% of the users of the particular Web service that are female, have visited the Web service 15 times, live in the Northwest US, and have an income in the $50,000-$75,000 range also are between the ages of 30 and 55, then the unknown element estimation module 206 determines an element score for the age element 312 as 0.7.

It should also be noted that the same or similar information matching or other machine learning techniques can be used by the fuzzy matching module 202. User data for users of a particular Web service at different times (e.g., different months, different weeks, different years) can be maintained as first party data. At least some of the user data can change over time, and these changes can be analyzed. This first party data regarding a particular service or system for which membership in a segment is being determined is obtained. The fuzzy matching module 202 uses the information matching or other machine learning techniques and the first party data to compare user data for the user to user data of other users of the particular service or system. The fuzzy matching module 202 determines how many (e.g., what percentage) of users having the same user data for at least one element eventually fully satisfied the element (or satisfied the element within a threshold amount of time, such as a particular number of hours, days, or weeks).

By way of example, referring again to FIG. 3, assume the segment criteria is for a particular Web service. The fuzzy matching module 202 analyzes the user data for other users of the particular Web service, and identifies how many (e.g., what percentage) of other users visited the particular Web service 15 times ended up eventually (or within a threshold amount of time) visiting the Web service 20 times (and thus fully satisfied the visitation element 316). The fuzzy matching module 202 uses that number of users as the element score. For example, if 45% of the users of the particular Web service ended up eventually (or within a threshold amount of time) visiting the Web service 20 times, then the fuzzy matching module 202 determines an element score for the visitation element 316 of 0.45.

The confidence value generation module 208 generates a confidence value that the user is included in the segment. The confidence value is generated based on the element scores generated by the fuzzy matching module 202, optionally by the weighted element scores generated by the custom weighting module 204, and optionally by the estimates for unknown elements generated by the unknown element estimation module 206. If weighting is used, then the weighted element scores generated by the custom weighting module 204 are combined (e.g., averaged or added) to generate the confidence value that the user is included in the segment. If weighting is not used, then the element scores generated by the fuzzy matching module 202 are combined (e.g., averaged or added) to generate the confidence value that the user is included in the segment. Additionally, element scores generated by the unknown element estimation module 206 can be combined with element scores generated by the fuzzy matching module 202 (or weighted element scores generated by the custom weighting module 204) to generate the confidence value.

For example, referring again to FIG. 3, assume that weighting is not used, and that the fuzzy matching module 202 generates an element score for the age element 312 of 1.0, an element score for the gender element 314 of 0.0, an element score for the visitation element 316 of 0.75, and an element score for the geographic location element 318 of 0.5. The confidence value generation module 208 generates a confidence value by averaging the values of 1.0, 0.0, 0.75, and 0.5, resulting in a confidence value that the user is member of the segment of 0.56.

By way of example, referring again to FIG. 3, assume that weighting is used and that the fuzzy matching module 202 generates a weighted score of 0.2 for the age element 312, a weighted score of 0.0 for the gender element 314, a weighted score of 0.45 for the visitation element 316 and a weighted score of 0.1 for the geographic location element 318. The confidence value generation module 208 generates a confidence value by averaging the values of 0.2, 0.0, 0.45, and 0.1, resulting in a confidence value that the user is member of the segment of 0.19.

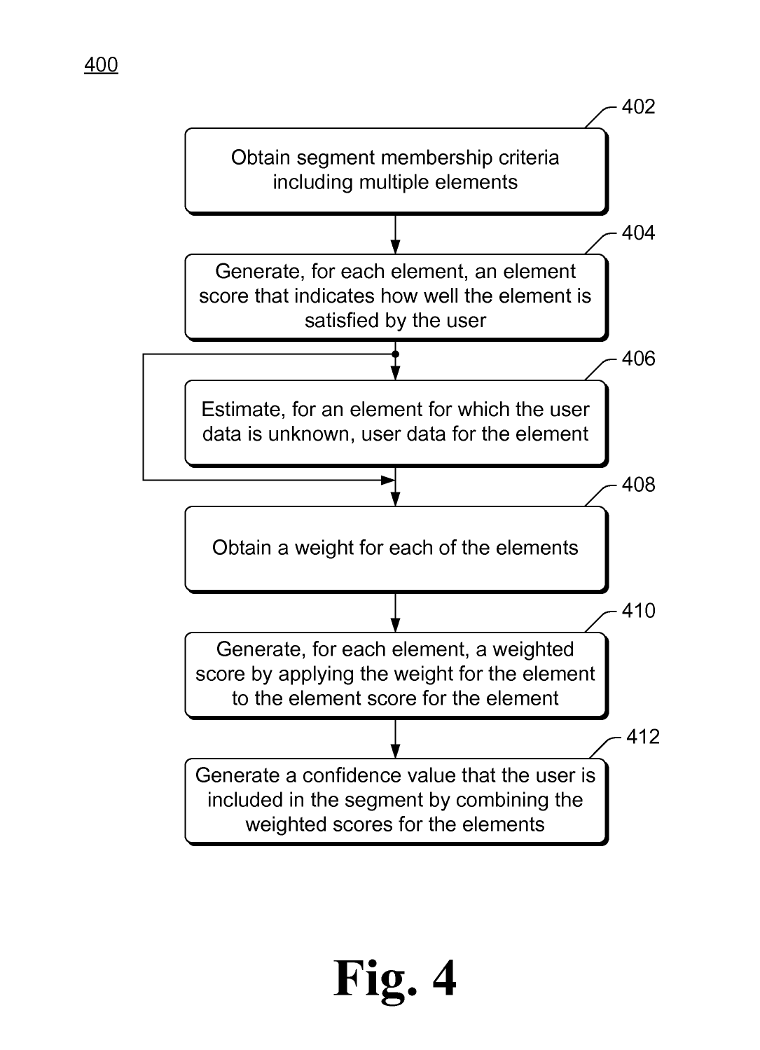

FIG. 4 is a flowchart illustrating an example process 400 for implementing segment membership determination for content provisioning in accordance with one or more embodiments. Process 400 is carried out by a device, such as device 100 of FIG. 1, and can be implemented in software, firmware, hardware, or combinations thereof. Process 400 is shown as a set of acts and is not limited to the order shown for performing the operations of the various acts. Process 400 is an example process for implementing segment membership determination for content provisioning; additional discussions of implementing segment membership determination for content provisioning are included herein with reference to different figures.

In process 400, segment membership criteria including multiple elements is obtained (act 402). The segment membership criteria for a segment is the criteria that is to be satisfied by characteristics of a user in order for the user to be a member of the segment. The segment membership criteria can be obtained from various different sources, and in one or more embodiments is maintained in a data store of the device implementing the process 400 as discussed above.

For each of one or more of the multiple elements in the segment membership criteria, an element score that indicates how well the element is satisfied by the user is generated (act 404). The element score is generated using a fuzzy matching technique as discussed above. In one or more embodiments, the element score for each element ranges between 0.0 and 0.1, although element scores can alternatively be generated using different ranges of numbers (e.g., a range of 1 to 10, a range of 1 to 100, and so forth).

For an element for which user data is unknown, the user data for the element is estimated (act 406). Situations can arise in which the user data for an element is unknown, in which case the user data is estimated despite having no data regarding the element for the user as discussed above. The user data can be estimated in a variety of different manners, such as using general statistics, using public data, using first party data, or using information matching or other machine learning techniques. It should be noted that act 406 is optional—if there is no unknown user data for an element of the segment membership criteria, then act 406 need not be performed.

A weight for each of the elements is also obtained (act 408). The weights for the elements indicate the importance of each element relative to the other elements in the set of criteria as discussed above. The weights can be obtained in a variety of different manners as discussed above.

For each element in the obtained segment membership criteria, a weighted score is generated by applying the weight for the element to the element score for the element (act 410). The weight for the element can be applied to the element score for the element in different manners, such as multiplying the weight for the element and the element score for the element.

A confidence value that the user is included in the segment is generated by combining the weighted scores for the elements (act 412). The weighted scores can be combined in different manners, such as being averaged, added together, and so forth. Alternatively, in some situations the confidence value is generated in act 410 by combining the element scores for the elements rather than the weighted scores for the elements (in which case acts 408 and 410 need not be performed).

The techniques discussed herein support a variety of different usage scenarios. The techniques discussed herein allow membership in a particular segment to be increased over other techniques that rely solely on using Boolean values to indicate that an element does or does not apply to a user. Confidence values that a user is a member of a segment, even if all of the criteria of the segment are not satisfied, allow a user that is “close enough” to be considered a member of a segment. This allows services and systems to provide the proper content to users, increasing user satisfaction with the services and systems, as well as increasing satisfaction of the owners or operators of such services and systems.

For example, the techniques discussed herein allow a service or system to increase membership in a particular segment to determine whether a particular advertisement is expected to apply to the user. By way of another example, the techniques discussed herein allow a service or system to determine how much to pay for the ability to provide an advertisement to a user based on the confidence that the user is a member of a particular segment. By way of yet another example, the techniques discussed herein allow a service or system to present different Web pages to a user, those Web pages being customized based on the confidence that the user is a member of a segment. By way of yet another example, the techniques discussed herein allow a service or system to present different periodicals, articles, or other content to a user based on the confidence that the user is a member of a segment.

The techniques can also be used in retail or traditional “brick and mortar” stores. A system in such a store can identify users as they enter the store, and determine membership of the user in a segment using the techniques discussed herein. Given this segment membership determination, a determination can be made as to what coupons or advertisements are to be provided to a device of the user (e.g., the user's wireless phone, watch, eyeglasses, etc.). The phone number, email address, or other information describing the user's device can have been previously provided to the store (e.g., by the user) to allow communication of such coupons or advertisements.

The techniques discussed herein also allow an estimate of unknown values to be determined, and confidence that the user is member of a particular segment determined based on those estimates. Thus, even though a system may know very little about a user, such as a new user where the only information available is the gender and geographic location of the user, estimates can be made and a confidence that the user is member of a particular segment determined based on those estimates as discussed above.

Various actions performed by various modules are discussed herein. A particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

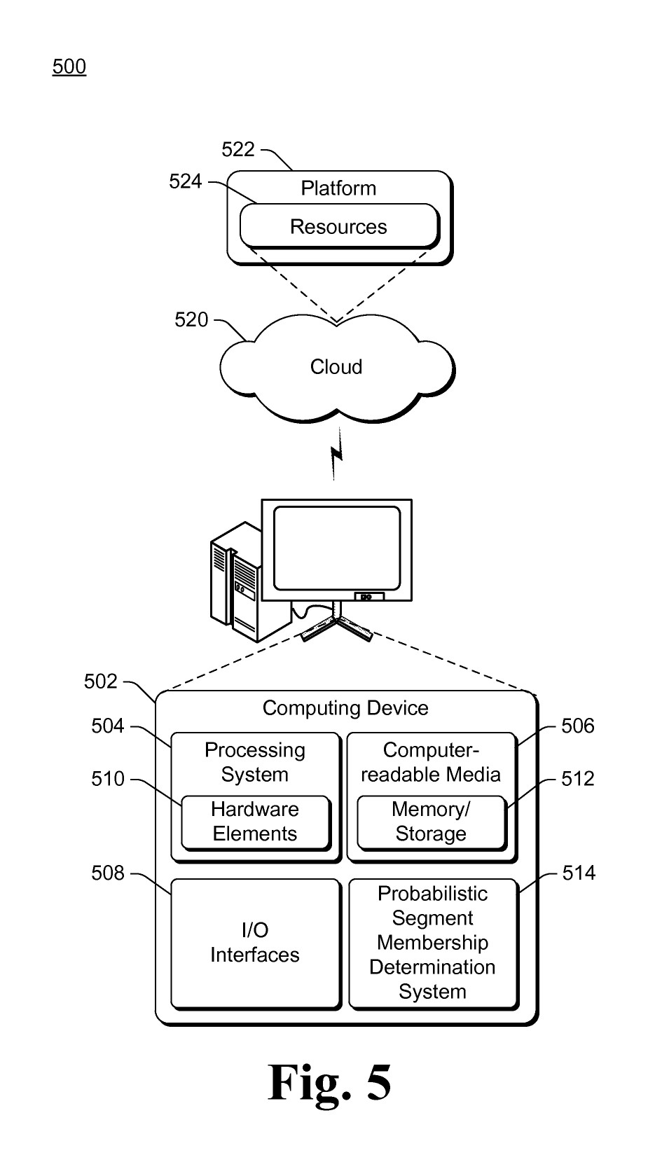

FIG. 5 illustrates an example system generally at 500 that includes an example computing device 502 that is representative of one or more computing systems and/or devices that may implement the various techniques described herein. This is illustrated through inclusion of the probabilistic segment membership determination system 514, which may be configured to determine segment membership for content provisioning as discussed herein. Computing device 502 may be, for example, a server of a service provider, a device associated with a client (e.g., a client device), an on-chip system, and/or any other suitable computing device or computing system. Computing device 502 may be computing device 100 of FIG. 1.

The example computing device 502 as illustrated includes a processing system 504, one or more computer-readable media 506, and one or more I/O interfaces 508 that are communicatively coupled, one to another. Although not shown, computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

Processing system 504 is representative of functionality to perform one or more operations using hardware. Accordingly, processing system 504 is illustrated as including hardware elements 510 that may be configured as processors, functional blocks, and so forth. This may include implementation in hardware as an application specific integrated circuit or other logic device formed using one or more semiconductors. Hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

Computer-readable storage media 506 is illustrated as including memory/storage 512. Memory/storage 512 represents memory/storage capacity associated with one or more computer-readable media. Memory/storage component 512 may include volatile media (such as random access memory (RAM)) and/or nonvolatile media (such as read only memory (ROM), Flash memory, optical disks, magnetic disks, and so forth). Memory/storage component 512 may include fixed media (e.g., RAM, ROM, a fixed hard drive, and so on) as well as removable media (e.g., Flash memory, a removable hard drive, an optical disc, and so forth). Computer-readable media 506 may be configured in a variety of other ways as further described below.

Input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, computing device 502 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by computing device 502. By way of example, and not limitation, computer-readable media may include “computer-readable storage media” and “computer-readable signal media.”

“Computer-readable storage media” refer to media and/or devices that enable persistent and/or non-transitory storage of information in contrast to mere signal transmission, carrier waves, or signals per se. Computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 510 and computer-readable media 506 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 510. Computing device 502 may be configured to implement particular instructions and/or functions corresponding to the software and/or hardware modules. Accordingly, implementation of a module that is executable by computing device 502 as software may be achieved at least partially in hardware, e.g., through use of computer-readable storage media and/or hardware elements 510 of processing system 504. The instructions and/or functions may be executable/operable by one or more articles of manufacture (for example, one or more computing devices 502 and/or processing systems 504) to implement techniques, modules, and examples described herein.

The techniques described herein may be supported by various configurations of computing device 502 and are not limited to the specific examples of the techniques described herein. This functionality may also be implemented all or in part through use of a distributed system, such as over a “cloud” 520 via a platform 522 as described below.

Cloud 520 includes and/or is representative of a platform 522 for resources 524. Platform 522 abstracts underlying functionality of hardware (e.g., servers) and software resources of cloud 520. Resources 524 may include applications and/or data that can be utilized while computer processing is executed on servers that are remote from computing device 502. Resources 524 can also include services provided over the Internet and/or through a subscriber network, such as a cellular or Wi-Fi network.

Platform 522 may abstract resources and functions to connect computing device 502 with other computing devices. Platform 522 may also serve to abstract scaling of resources to provide a corresponding level of scale to encountered demand for resources 524 that are implemented via platform 522. Accordingly, in an interconnected device embodiment, implementation of functionality described herein may be distributed throughout system 500. For example, the functionality may be implemented in part on computing device 502 as well as via platform 522 that abstracts the functionality of the cloud 520.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of determining, in a device, whether a user is included in a segment, the method comprising:
obtaining, from a data store of the device, segment membership criteria for the segment, the segment membership criteria including multiple different elements;
for at least a first element of the multiple elements, generating an element score that indicates how well the element is satisfied by the user, the element score being one of at least three different values;
obtaining, from the data store, a weight for each of the multiple elements;
generating, by the device for each of the multiple elements, a weighted score, the weighted score for each of at least the first element being generated by applying the weight for the element to the element score for the element; and
generating, by combining the weighted scores for the multiple elements, a confidence value that the user is included in the segment.

2. The method of claim 1, further comprising determining, in response to the confidence value satisfying a threshold value, that the user is included in the segment.

3. The method of claim 2, further comprising providing first content for display in response to determining that the user is included in the segment, and providing second content for display in response to determining that the user is not included in the segment, the first content and the second content being different content.

4. The method of claim 1, further comprising determining, based on the confidence value, an amount to pay to provide content to the user, different amounts to pay being determined for different confidence values.

5. The method of claim 1, further comprising, for each of at least a second element of the multiple elements, generating an element score for the element that indicates how well the element is satisfied by the user despite having no data regarding the element for the user.

6. The method of claim 5, further comprising, for each of at least the second element of the multiple elements, generating an element score that indicates how well the element is satisfied by the user using general statistics associated with the element.

7. The method of claim 5, further comprising, for each of at least the second element of the multiple elements, generating an element score that indicates how well the element is satisfied by the user using public data associated with the element.

8. The method of claim 5, further comprising, for each of at least the second element of the multiple elements, generating an element score that indicates how well the element is satisfied by the user using data regarding other users of a service that is determining whether the user is included in the segment.

9. The method of claim 8, further comprising, for each of at least the second element of the multiple elements, the generating the element score further comprising generating the element score using data regarding the other users for elements of the multiple elements other than the second element.

10. A device comprising:
one or more processors;
a storage device;
one or more computer-readable media having stored thereon multiple instructions that, when executed by the one or more processors, cause the one or more processors to perform acts comprising:
obtaining, from the storage device, segment membership criteria for a segment, the segment membership criteria including multiple different elements;
generating, for each of the multiple elements, an element score that indicates how well the element is satisfied by a user, the element score being a value in a range of values that includes three or more different values;
obtaining a weight for each of the multiple elements;
generating, by the device for each of the multiple elements, a weighted score by applying the weight for the element to the element score for the element; and
generating, by combining the weighted scores for the multiple elements, a confidence value that the user is included in the segment.

11. The device of claim 10, the acts further comprising determining, in response to the confidence value satisfying a threshold value, that the user is included in the segment.

12. The device of claim 10, the generating the element score including, for at least one element of the multiple elements, an element score for the at least one element that indicates how well the at least one element is satisfied by the user despite the device having no data regarding the element for the user.

13. The device of claim 12, the generating the element score for the at least one element comprising generating the element score for the at least one element using general statistics associated with the element.

14. The device of claim 12, the generating the element score for the at least one element comprising generating the element score for the at least one element using public data associated with the element.

15. The device of claim 12, the generating the element score for the at least one element comprising generating the element score for the at least one element using data regarding other users of a service that is implemented by the device.

16. The device of claim 12, the generating the element score for the at least one element comprising generating the element score for the at least one element using data regarding the other users for elements of the multiple elements other than the at least one element.

17. A device comprising:
a storage device;
a segmentation-based content provisioning system;
a probabilistic segment membership determination system configured to:
obtain, from the storage device, segment membership criteria for a segment, the segment membership criteria including multiple different elements;
for at least a first element of the multiple elements, generate an element score that indicates how well the element is satisfied by a user, the element score being one of at least three different values;
obtain, from the storage device, a weight for each of the multiple elements;
generate, by the device for each of the multiple elements, a weighted score, the weighted score for each of at least the first element being generated by applying the weight for the element to the element score for the element;
generate, by combining the weighted scores for the multiple elements, a confidence value that the user is included in the segment; and
communicate the confidence value to the segmentation-based content provisioning system; and
the segmentation-based content provisioning system being configured to determine, in response to the confidence value satisfying a threshold value, that the user is included in the segment.

18. The device of claim 17, the probabilistic segment membership determination system being further configured to, for each of at least a second element of the multiple elements, an element score for the element that indicates how well the element is satisfied by the user despite the probabilistic segment membership determination system having no data regarding the element for the user.

19. The device of claim 18, the probabilistic segment membership determination system being further configured to, for each of at least the second element of the multiple elements, generate an element score that indicates how well the element is satisfied by the user using public data associated with the element.

20. The device of claim 18, the probabilistic segment membership determination system being further configured to, for each of at least the second element of the multiple elements, generate an element score that indicates how well the element is satisfied by the user using data regarding other users of the segmentation-based content provisioning system.
